(19) United States
(12) Patent Application Publication
(10) Pub. No.: US 2011/0141470 A1
(43) Pub. Date: Jun. 16, 2011

(54) Servo-Controlled Bistatic Anemometric Probe

(75) Inventors: Alain RENARD, Chabeuil (FR); Philippe RONDEAU, Saint Marcel les Valence (FR); Xavier LACONDEMINE, Valence (FR)

(73) Assignee: THALES, Neuilly-sur-Seine (FR)

(21) Appl. No.: 12/964,393

(22) Filed: Dec. 9, 2010

(30) Foreign Application Priority Data
Dec. 11, 2009 (FR) 09 06001

(51) Int. Cl. G01N 21/00

(52) U.S. Cl. 356/342

(57) ABSTRACT

Bistatic anemometric optical probes include an emitting first optical head that illuminates a measurement region and a receiving second optical head. The probe includes: optomechanical movement means for moving one of the optical axes of the optical heads in at least one direction called the measurement direction, the optical axis moved being the movable optical axis; measuring means arranged so as to distribute the intensity of the beam backscattered from the measurement region in at least two directions located on either side of the measurement direction and denoted servo-control directions; and a servo-control device connected to the measuring means and to the optomechanical means of moving, said servo-control device including functions making it possible, on the one hand, to determine, from knowledge of the intensity of the backscattered beam in the two servo-control directions, the offset between the measurement direction of the movable optical axis and a direction, called the optimal direction, making it possible to maximize the intensity of the backscattered beam and, on the other hand, to servo-control the direction of said movable optical axis to the optimal direction.

### CROSS-REFERENCE TO RELATED APPLICATION

This application claims priority to foreign French patent application No. FR 0906001, filed on Dec. 11, 2009, the disclosure of which is incorporated by reference in its entirety.

### FIELD OF THE INVENTION

The field of the invention is that of optical anemometry and in particular that of optical anemometry onboard aircraft.

### BACKGROUND

To pilot an aircraft, it is necessary to know at least its relative altitude, its velocity relative to the ambient air and its angle of attack. These various data may be measured locally, in the near field, close to the skin of the aircraft or in the far field, beyond the aerodynamic field created by the aircraft. Near-field data is conventionally obtained by measuring a set of aerodynamic parameters. Far-field data is measured using optical anemometry devices called Lidar (light detection and ranging) devices. A Lidar device emits and receives light along a defined measurement axis. In conventional Lidar anemometer architectures, the atmosphere is illuminated with a laser beam and the power backscattered by particles and/or molecules present along the path of the beam is collected. The longitudinal velocity of the scattering particles relative to the Lidar system then produces a Doppler shift which is measured by heterodyne detection. In many applications it is desired to know the distance at which the scatterers that produced the signal received are located. For this purpose, several methods may be used:
a pulsed laser source may be used. The time of flight of the wave is measured so as to know the measurement distance;
the emitted beam may be focused. The region on which the beam is focused provides more efficient illumination and collection of the backscattered signal; and
a system, called a “bistatic” system, where the emitting and collecting optics are separate, may be used. Only the overlap volume, i.e. the overlap between the beam-illuminated volume and the efficient-collection volume, produces a signal.

In the case of Lidar velocimetry probes onboard aircraft, these solutions have certain drawbacks detailed below:
the pulsed laser solution may have problems with the wavelength stability of the emitted laser beam and with spectral broadening of the received signal due to the short duration of the pulses, necessary to achieve sufficient distance precision;
the focusing selectivity solution attenuates distant echoes only proportionally to the square of the distance between the point of focus and the distant echo, namely a cloud or the ground—this selectivity therefore proves to be insufficient; and finally
bistatic systems have a good spatial selectivity but they are very sensitive to misalignment of the emitting and receiving optics making them in general difficult to use in an onboard system.

A conventional bistatic architecture is illustrated in FIG. 1, essentially comprising:
a laser source 10 supplying a linearly-polarized reference wave;
a splitting device 11, which may be, by way of example, a 50/50 beam splitter, shares the power supplied by this source between two paths called the reference path and the power path;
the power path takes one of the two outputs of the splitting device 11 as input, it passes through the optical amplifier 12 and is then projected into the atmosphere to the desired measurement distance by a first telescope 13, thus creating an illuminated volume;
a second telescope 14 gathers the flux backscattered by sources (particles, aerosols, etc.) present in its efficient-collection volume and couples this flux into the return path of the signal;
the overlap between the volume illuminated by the telescope 13 and the volume for efficient collection by the telescope 14 produces the measurement volume 20 that generates the Doppler signal; and
a mixing device 15, which may be an interferometer or, when the optical beams are fibre-optic beams, an optical coupler, allows coherent recombination of the backscattered wave and the wave from the reference path into two beams that are directed onto the two diodes of a balanced detector 16 that delivers a measurement signal S. The reference wave has the same polarization as the signal collected by appropriate optical means (not shown in FIG. 1).

To give orders of magnitude, the alignment precision of the beams of the first and second telescopes must be less than a few microradians. Such precision is very difficult to maintain in onboard devices due to the thermal and vibratory environment of the aircraft.

### SUMMARY OF THE INVENTION

The device according to the invention allows these drawbacks to be alleviated. The invention includes servo-controlling the direction of one of the two telescopes so that their illumination and efficient-collection beams always intersect. The method of implementing the invention may comprise an initial acquisition phase, so that the intersection of the beams may be localized in the case of an imprecise initial setting, and then a tracking phase so that the most powerful backscattered signal possible is supplied. The solution envisioned allows a very high selectivity and a high precision to be achieved. In addition, it is easily fitted to existing bistatic architectures by means of minor modifications. It is perfectly suited to the measurement conditions and to the atmosphere and is largely insensitive to any drift due, for example, to harsh environments.

More precisely, the subject of the invention is a “bistatic” anemometric optical probe comprising at least an emitting first optical head and a receiving second optical head, the first optical head being oriented along a first optical axis and focusing an emitted beam onto a measurement region, the receiving second optical head being oriented along a second optical axis different to the first optical axis and collecting a beam backscattered by said measurement region, the probe also comprising means for measuring the backscattered beam via the receiving second optical head, characterized in that the probe comprises:
optomechanical movement means for moving the first or second optical axis in at least one direction called the measurement direction, the optical axis moved being denoted movable optical axis;
measuring means being arranged so as to distribute the intensity of the beam backscattered between at least two directions located on either side of the measurement direction and denoted servo-control directions; and
a servo-control device connected to the measuring means and to the optomechanical movement means, said servo-control device comprising functions making it possible:
   on the one hand, to determine, from knowledge of the intensity of the beam backscattered in the two servo-control directions, the offset between the measurement direction of the movable optical axis and a direction, called the optimal direction, making it possible to maximize the intensity of the backscattered beam; and
   on the other hand, to servo-control the direction of said movable optical axis to the optimal direction.

The probe according to the invention comprises two embodiments.

Advantageously, in a first embodiment, the measuring means comprises a central detector and two first lateral detectors located on either side of said central detector and means for determining, from knowledge of the signals output by the lateral detectors, the offset between the measurement direction of the movable optical axis and the optimal direction. Preferably, the measuring means comprises two second lateral detectors located on either side of said central detector, the four detectors being placed in a diamond pattern, the measuring means comprising means for determining, from knowledge of the signals output by the four lateral detectors, the offsets in two perpendicular planes between the measurement direction of the movable optical axis and the optimal direction.

Advantageously, in a second embodiment, the probe comprises optomechanical movement means for making the movable optical axis oscillate about the measurement direction, the measuring means being arranged so as to distribute the intensity of the backscattered beam as a function of time, said intensity varying in time as a function of the oscillation of the optical axis; and the servo-control device comprising means making it possible to determine, from knowledge of the variation in the intensity of the backscattered beam, the offset between the measurement direction of the oscillating optical axis and the optimal direction. Preferably, the servo-control device comprises an electronic device for controlling the optomechanical movement means, said electronic control device comprising an excitation generator, a synchronous demodulator connected to the measuring means and to the excitation generator, a feedback control loop filter connected to the synchronous demodulator and a summer, the inputs of which are connected to the synchronous demodulator and to the excitation generator and the output of which is connected to the optomechanical movement means, the synchronous demodulator providing functions for determining, from knowledge of the variation in intensity of the backscattered signal, the offset between the current direction of the oscillating optical axis and the optimal direction, making it possible to maximize the intensity of the backscattered beam. The direction of movement of the oscillating optical axis may lie in a plane passing through the first and second optical axes.

### BRIEF DESCRIPTION OF THE DRAWINGS

The invention will be better understood and other advantages will become clear on reading the following non-limiting description and by virtue of the appended figures in which:

FIG. 1 shows a bistatic anemometric probe according to the prior art;

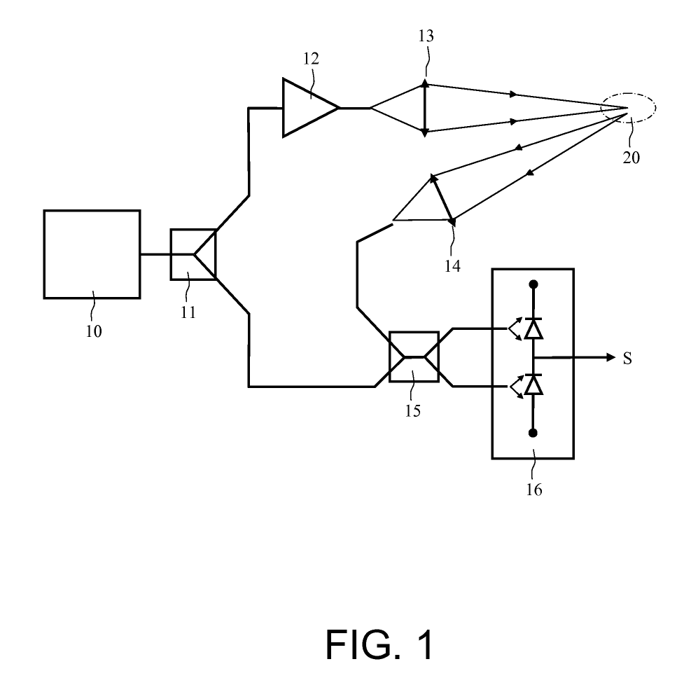

FIG. 2 shows a bistatic anemometric probe comprising a first embodiment of the servo-control according to the invention; and

FIG. 3 shows a bistatic anemometric probe comprising a second embodiment of the servo-control according to the invention.

### DETAILED DESCRIPTION

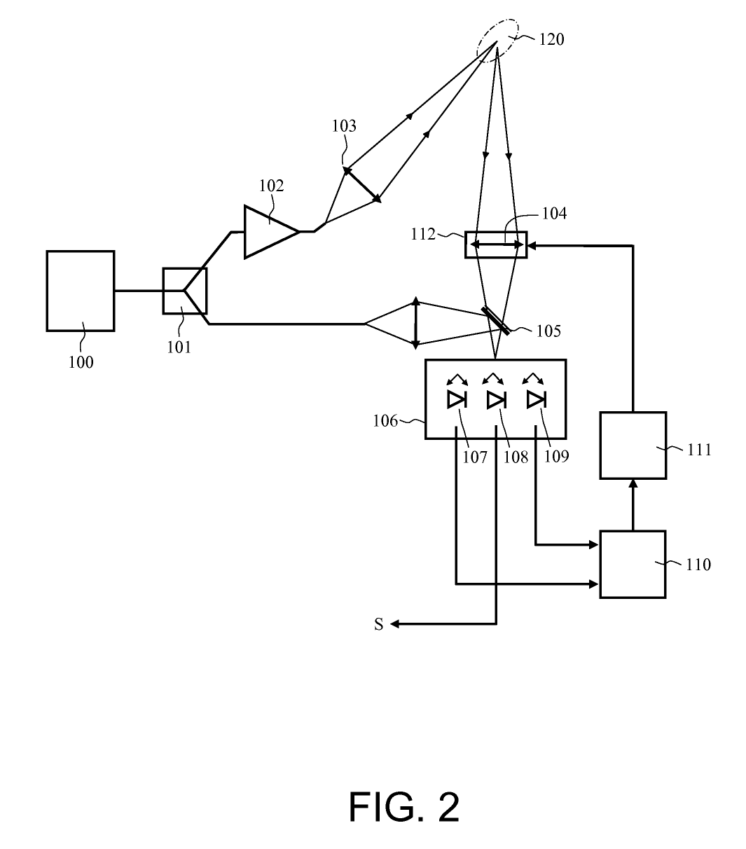

By way of a first non-limiting example, FIG. 2 shows the architecture of a bistatic anemometric probe having a first servo-control system according to the invention. In the architecture shown, the various optical or optoelectronic elements are connected together using polarization-maintaining optical fibres. The probe comprises:
a laser source 100 supplying a linearly-polarized reference wave;
a splitting device 101 sharing the power supplied by this source between two paths: the reference path and the power path. This device 101 may be, by way of example, a 50/50 beam splitter;
the power path takes one of the two outputs of the splitting device 101 as input, it passes through the amplifier 102 and is then projected into the atmosphere to the desired measurement distance by a first optical head or first telescope 103. A measurement volume 120 is thus formed;
a second optical head or second telescope 104 gathers some of the flux backscattered by the measurement volume 120 and delivers the Doppler signal as output; and
a mixing device i.e. a conventional splitter-plate interferometer 105 in the case of FIG. 2. This device may be, in the case of fibre-optic probes, an optical coupler. It enables coherent recombination of the two beams coming, on the one hand, from the reference path and, on the other hand, from the measurement path, towards the three diodes of a detection array 106, the reference wave having the same polarization as the collected signal.

The probe also comprises means for positioning the optical axis of the second optical head so that it best crosses the optical axis of the first optical head. The maximum measurement volume common to the two optical heads is thus obtained. Obviously, when the optical axis is in this optimal direction, the intensity of the backscattered signal is maximized.

To determine whether the measurement direction effectively corresponds to this optimal direction, three detectors, arranged in a line, are placed in the focal plane of the receiving optical head, namely a central detector 108 and two lateral detectors 107 and 109 located on either side of the central detector. The central detector 108 delivers the measurement signal S and the two lateral detectors 107 and 109 are used for servo-control. The lateral detectors therefore pick up a backscattered signal in a direction slightly different to the measurement direction. If these lateral signals are of the same magnitude and if this magnitude is lower than that delivered by the central detector, it is possible to conclude that the measurement direction corresponds to the optimal direction. If this is not the case, then the amplitude offset between the lateral signals is representative of the angular offset between the measurement direction and the optimal direction.

This offset may be easily measured using the comparator 110 and then integrated by the integrator 111 so as to generate a continuous control signal applied by the control device 112 of the optomechanical movement means allowing the optical axis of the telescope 104 to be moved. Of course, it is also possible for this telescope to remain stationary and for the optical head 103 to be moved. The same type of servo-control is obtained. There are various means 112 for orienting the optical axis of the telescope 104. By way of a first example, the telescope 104 may be mounted on a mechanical angular-positioning device that moves the entire telescope. It is also possible to move one of the optical elements of the optical head or to add, before the telescope, a rotable element, such as a diasporameter. It is also possible to move the mechanical support bearing the three, measurement and servo-control, detectors. The system shown in FIG. 2 servo-controls the measurement direction in a given plane, in this case in the plane of the paper. A priori, servo-control on a single axis is indispensable only in the direction orthogonal to the plane of the two, emitting and receiving, telescopes, taking account of the characteristics thereof. However, the same principle may be applied simultaneously in a direction parallel to the plane of the paper. To do this, it is enough for the measuring means to comprise two second lateral detectors located on either side of the central detector, the four detectors being placed in a diamond pattern, the measuring means comprising means for determining, from knowledge of the signals output by the four lateral detectors, the offsets in two perpendicular planes between the measurement direction of the movable optical axis and the optimal direction. This arrangement does not present any particular difficulties. Still remaining within the scope of this invention, it is possible to envision other combinations of detectors.

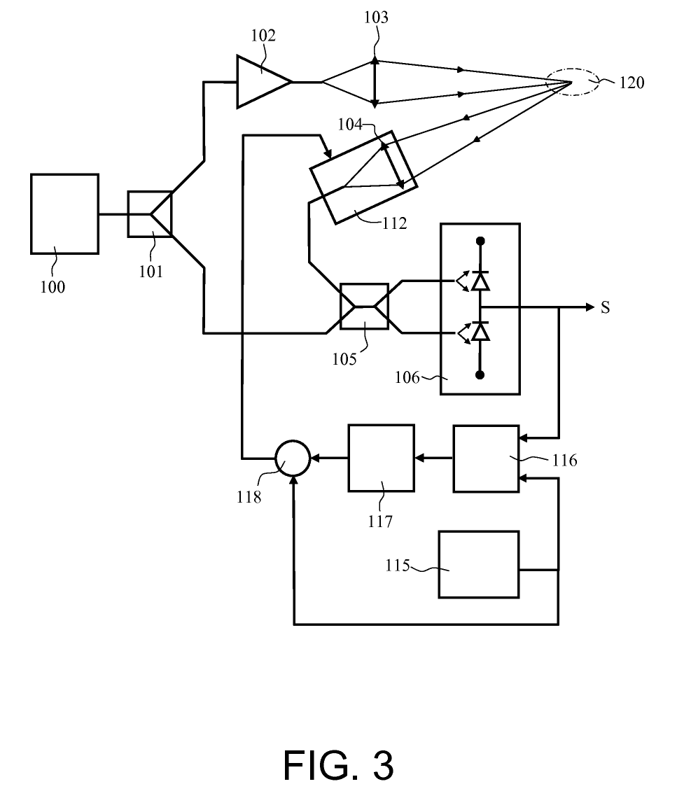

By way of a second non-limiting example, FIG. 3 shows the architecture of a bistatic anemometric probe having a second servo-control system according to the invention. In the architecture shown, the various optical or optoelectronic elements are connected together using polarization-maintaining optical fibres. The probe comprises, as above:
a laser source 100;
a splitting device 101;
a power path comprising an amplifier 102 and a first optical head or first telescope 103. A measurement volume 120 is thus formed;
a receiving second optical head or second telescope 104 that delivers the Doppler signal S as output;
a mixing device 105; and
a balanced detector 106 using two detection diodes.

The probe also comprises means for positioning the optical axis of the second optical head so that it best crosses the optical axis of the first optical head, called the optimal direction. If the optical axis is oscillated about this optimal direction, the amplitude of the signal varies symmetrically about this maximum. If the amplitude of the signal varies asymmetrically about a maximum, this means that the average direction of the oscillation no longer corresponds to the optimal direction. In this case, the amplitude offset corresponding to the extreme positions of the oscillation is representative of the correction to be made. It is easy to servo-control the oscillations so that the intensity of the backscattered signal varies symmetrically about a maximum. It is then certain that the oscillations takes place about the optimal direction.

The various means necessary for achieving this servo-control are:
optomechanical movement means 112 making it possible, on the one hand, to move the optical axis of the telescope 104 in at least one direction and, on the other hand, to make said axis oscillate about said direction. These means were described in the context of the above embodiment;
an arrangement of the measuring means 106 so as to distribute the intensity of the backscattered beam, said intensity varying in time as a function of the oscillation of the optical axis of the telescope 104;
a servo-control device connected to the measuring means and to the optomechanical movement means 112, said servo-control device comprising functions making it possible:
   on the one hand, to determine, from knowledge of the variation in the intensity of the backscattered beam, the offset between the measurement direction of the movable optical axis and a direction called the optimal direction, making it possible to maximize the intensity of the backscattered beam; and
   on the other hand, to servo-control the direction of said movable optical axis to the optimal direction.

In the present case, these various functions of the servo-control device are carried out by:
an excitation generator 115;
a synchronous demodulator 116;
a suppressor filter 117 that removes components at the excitation frequency and extracts the alignment offset from the intensity variation of the backscattered beam;
a summer 118 making it possible to inject, into the optomechanical movement means 112, the sum of the excitation signal coming from the generator 115 and of the alignment offset signal coming from the suppressor filter 117.

What is claimed is:

1. A bistatic anemometric optical probe comprising at least an emitting first optical head and a receiving second optical head, the first optical head being oriented along a first optical axis and focusing an emitted beam onto a measurement region, the receiving second optical head being oriented along a second optical axis different to the first optical axis and collecting a beam backscattered by said measurement region, the probe also comprising means for measuring the backscattered beam via the receiving second optical head, the probe further comprising:
optomechanical movement means to make the first or the second optical axis oscillate about a direction called the measurement direction, the oscillating optical axis being denoted movable optical axis;
measuring means placed so as to distribute the intensity of the backscattered beam as a function of time, said intensity varying in time as a function of the oscillation of the optical axis; and
a servo-control device connected to the measuring means and to the optomechanical movement means, said servo-control device comprising functions making it possible
on the one hand, to determine, from knowledge of the variation in the intensity of the backscattered beam, the offset between the measurement direction of the movable optical axis and a direction called the optimal direction, making it possible to maximize the intensity of the backscattered beam; and
on the other hand, to servo-control the direction of said movable optical axis to the optimal direction.

2. The bistatic anemometric optical probe according to claim 1, wherein the measuring means further comprises a central detector and two first lateral detectors located on either side of said central detector and means for determining, from knowledge of the signals output by the lateral detectors, the offset between the measurement direction of the movable optical axis and the optimal direction.

3. The bistatic anemometric optical probe according to claim 2, wherein the measuring means further comprises two second lateral detectors located on either side of said central detector, the four detectors being placed in a diamond pattern, the measuring means further comprising means for determining, from knowledge of the signals output by the four lateral detectors, the offsets in two perpendicular planes between the measurement direction of the movable optical axis and the optimal direction.

4. The bistatic anemometric optical probe according to claim 1, wherein the servo-control device further comprises an electronic device for controlling the optomechanical movement means, said electronic control device further comprising an excitation generator, a synchronous demodulator connected to the measuring means and to the excitation generator, a feedback control loop filter connected to the synchronous demodulator and a summer, the inputs of which are connected to the synchronous demodulator and to the excitation generator and the output of which is connected to the optomechanical movement means, the synchronous demodulator providing functions for determining, from knowledge of the variation in intensity of the backscattered signal, the offset between the current direction of the oscillating optical axis and an optimal direction, making it possible to maximize the intensity of the backscattered beam.

5. The bistatic anemometric optical probe according to claim 4, wherein the direction of movement of the oscillating optical axis lies in a plane passing through the first and second optical axes.
